(19) United States
(12) Patent Application Publication
(10) Pub. No.: US 2024/0254412 A1
(43) Pub. Date: Aug. 1, 2024

(54) MACHINE DISHWASH DETERGENT

(71) Applicant: Conopco Inc., d/b/a UNILEVER, Englewood Cliffs, NJ (US)

(72) Inventors: Robert John Carswell, Wageningen (NL); Katherine Mary Thompson, Wageningen (NL); Marc Philip Woolfall, Wageningen (NL)

(73) Assignee: Conopco Inc., d/b/a UNILEVER, Englewood Cliffs, NJ (US)

(21) Appl. No.: 18/563,418

(22) PCT Filed: May 17, 2022
(86) PCT No.: PCT/EP2022/063285

§ 371 Date: Nov. 22, 2023

(30) Foreign Application Priority Data
Jun. 3, 2021 (EP) 21177599.4

(51) Int. Cl. C11D 3/33; C11D 1/825; C11D 3/06; C11D 3/32; C11D 3/36; C11D 3/395; C11D 3/40; C11D 3/50; C11D 17/00

(52) U.S. Cl. CPC C11D 3/33; C11D 1/8255; C11D 3/06; C11D 3/32; C11D 3/361; C11D 3/3958; C11D 3/40; C11D 3/50; C11D 17/0047

(57) ABSTRACT

A machine dishwash detergent composition comprising from 0.1 to 20 wt. % non-ionic surfactant; and from 0.5 to 40 wt. % of free acid equivalent of aminopolycarboxylate; and from 0.5 to 3.8 wt. % of free acid equivalent of selected hydroxamate, wherein the amount of phosphate is at most 1.0 wt. %; and wherein the amount of phosphonate is at most 1.0 wt. %.

### TECHNICAL FIELD OF THE INVENTION

The present invention relates to a machine dishwash detergent composition comprising hydroxamic acid and its corresponding salt.

### BACKGROUND OF THE INVENTION

Machine dishwash detergent compositions typically contain several different active components, including builders, surfactants, enzymes and bleaching agents. Surfactants are employed to remove stains and soil and to disperse the released components into the cleaning liquid. Enzymes help to remove stubborn stains of proteins, starch and lipids by hydrolyzing these components. Bleach is used to remove stains by oxidizing the components that make up these stains. To reduce the negative effects of calcium and magnesium ions on stain/soil removal so called ‘builders’ (complexing agents) are commonly applied in detergent compositions.

Phosphonates are highly effective components of modern dishwasher detergent compositions. They contribute to achieving cleaning performance and hygiene at lower wash temperatures and less intensive wash cycles, reducing energy consumption, water use and detergent doses. In phosphate-free laundry and dishwasher detergents, phosphonates are particularly important to achieve this eco-performance. Furthermore, phosphonates have a beneficial effect on reducing spotting incidence of washed wares. Phosphonates are also chemically stable which means they are compatible with other detergent components, such as bleach and are little affected by alkaline pH conditions in the detergent or the wash liquor. This stability also has a downside as phosphonates tend to biodegrade rather slowly. Furthermore, they contain phosphorous which can lead to eutrophication of the environment. An example of a widely used phosphonate in machine dishwash detergents is HEDP (1-hydroxyethylidene-1,1-disphosphonic acid).

Phosphate based builders have been used for many years in machine dishwash detergent compositions. Trisodium phosphate and sodium tripolyphosphate (STPP), have set a benchmark in the dishwasher detergent industry as having excellent performance. The use of phosphate-based builders in detergent compositions has likewise led to environmental problems such as eutrophication. As such there has been a need for more environmentally friendly alternative builders, which have on-par effectiveness and which are also cost-effective. Examples of such alternative builders are aminopolycarboxylates, such as glutamic acid N,N-diacetic acid (GLDA), methylglycinediacetic acid (MGDA) and are ethylenediaminetetraacetic acid (EDTA).

There is thus a constant desire to make machine dishwash detergents more environmentally friendly and for phosphate and phosphonate free machine dishwash detergent compositions. A prime requisite for consumer acceptance is that such detergents need to perform well in cleaning dishware and provide acceptably low incidence of spotting.

WO2020/070544 A1 is directed to more environmentally friendly machine dishwash compositions which have improved biodegradability and can be phosphonate free. In the context of machine dishwash compositions containing MGDA worse spotting is observed on glass when compared to compositions containing HEDP (See FIG. 5 in combination with the detergent use (Base A).

EP2963102 A2 discloses machine dishwash compositions having high amounts of phosphate and up to 2 wt. % phosphonate (See paragraph [0095]). The experiments test the effect of hydroxamate on removing soils from dishes. The precise amount of hydroxamate used in the examples is not derivable.

DE19615287 A1 discloses the use of hydroxamic acids and their salts as silver-protection agent.

It is an object of the present invention to provide a machine dishwash detergent which is phosphate-free and comprises aminopolycarboxylate, and which is also phosphonate-free yet still provides low incidence of spotting on washed dishware, especially on earthenware washed wares. The latter is of growing interest as earthenware is nowadays typically glazed, which means any spots are readily visible. In addition, earthenware can be favored by consumers as safer and more robust in use than glass-based ware and more environmentally friendly than plasticware.

### SUMMARY OF THE INVENTION

One or more objects of the invention have been achieved in a first aspect by a machine dishwash detergent composition comprising:
from 0.1 to 20 wt. % non-ionic surfactant; and
from 0.5 to 40 wt. % of free acid equivalent of aminopolycarboxylate; and
from 0.5 to 3.8 wt. % of free acid equivalent of hydroxamate:

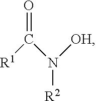

wherein R¹ is a straight or branched C₄-C₂₀ alkyl, or a straight or branched substituted C₄-C₂₀ alkyl, or a straight or branched C₄-C₂₀ alkenyl, or a straight or branched substituted C₄-C₂₀ alkenyl, or an alkyl ether group CH₃ (CH₂)ₙ (EO)ₘ wherein n is from 2 to 20 and m is from 1 to 12, or a substituted alkyl ether group CH₃ (CH₂)ₙ (EO)ₘ wherein n is from 2 to 20 and m is from 1 to 12, and the types of substitution include one or more of —NH₂, —OH, —S—, —O—, —COOH, and

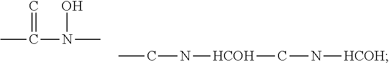

and R² is selected from hydrogen and a moiety that forms part of a cyclic structure
with a branched R¹ group, and
   wherein the amount of phosphate is at most 1.0 wt. %; and
   wherein the amount of phosphonate is at most 1.0 wt. %.

Unless otherwise made clear from the context, where the terms ‘hydroxamic acid’, ‘aminopolycarboxylic acid’ or ‘organic acid’ are used these encompass their corresponding salts (and vice versa). When added in their salt form the alkali metal salts are preferred, in particular their sodium or potassium salts.

Surprisingly a machine dishwash detergent composition comprising hydroxamic acid at the level of 2 wt. % provides a superior reduction in spotting incidence on earthenware compared to the use of 2 wt. % of HEDP. More surprisingly, adding hydroxamic acid at a level of 5.0 wt. % did not provide such a superior benefit versus the use of HEDP. Not unimportant, hydroxamic acid is highly biodegradable.

The invention also relates to the use of from 0.5 to 3.8 wt. % of free acid equivalent of hydroxamic acid to reduce spotting in a phosphate-free machine dishwash detergent composition, preferably one which is also phosphonate-free.

### DETAILED DESCRIPTION OF THE INVENTION

### Definitions

Weight percentage (wt. %) is based on the total weight of the detergent composition unless otherwise indicated or as made clear from the context. It will be appreciated that the total weight amount of ingredients will not exceed 100 wt. %. Whenever an amount or concentration of a component is quantified herein, unless indicated otherwise, the quantified amount or quantified concentration relates to said component per se, even though it may be common practice to add such a component in the form of a solution or of a blend with one or more other ingredients. It is furthermore to be understood that the verb “to comprise” and its conjugations is used in its non-limiting sense to mean that items following the word are included, but items not specifically mentioned are not excluded. Finally, reference to an element by the indefinite article “a” or “an” does not exclude the possibility that more than one of the elements is present, unless the context clearly requires that there be one and only one of the elements. The indefinite article “a” or “an” thus usually means “at least one”. Unless otherwise specified all measurements are taken at standard conditions. Whenever a parameter, such as a concentration or a ratio, is said to be less than a certain upper limit it should be understood that in the absence of a specified lower limit the lower limit for said parameter is 0.

Concentrations expressed in wt. % of ‘free acid equivalent’ refer to the concentration of the compound expressed as wt. %, assuming it would be in fully protonated from. The following table shows how the free acid equivalent concentrations can be calculated for some (anhydrous) aminopolycarboxylates and (anhydrous) acid salts.

| | Wt. % | Conversion | Wt. % free acid |
|---|---|---|---|
| | salt | factor | equivalent |
| GLDA (tetrasodium salt) | 50 | 263.1/351.1 | 37.5 |
| MGDA (trisodium salt) | 50 | 205.1/271.1 | 37.8 |
| Citric acid (monosodium | 50 | 192.1/214.1 | 44.9 |
| salt) | | | |
| Sodium acetate | 50 | 60.0/82.0 | 36.6 |
| Octanohydroxamic acid K- | 50 | 158/197 | 40 |
| salt | | | |

### Non-Ionic Surfactants

Suitable non-ionic surfactants which may be used include preferably the reaction products of compounds having a hydrophobic group and a reactive hydrogen atom, for example, aliphatic alcohols, acids, amides or alkyl phenols with alkylene oxides, especially ethylene oxide either alone or with propylene oxide.

Preferably low-foaming nonionic surfactants are used particularly from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. The preferred ethoxylated alcohols include for example C₁₂₋₁₄ alcohols with 3 EO to 4 EO, C₉₋₁₂ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₉ alcohol with 5 EO. Preferred tallow fatty alcohols with more than 12 EO have from 60 to 100 EO, and more preferably from 70 to 90 EO. Particularly preferred tallow fatty alcohols with more than 12 EO are tallow fatty alcohols with 80 EO.

Nonionic surfactants from the group of alkoxylated alcohols, particularly preferably from the group of mixed alkoxylated alcohols and in particular from the group of EO-AO-EO nonionic surfactants, are likewise particularly preferentially used. Preferably used nonionic surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene (PO/EO/PO). Such (PO/EO/PO) nonionic surfactants are furthermore distinguished by good foam control.

The most preferred nonionic surfactants are according to the formula:

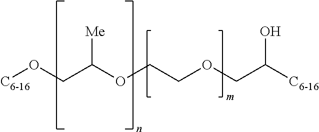

wherein n is from 0 to 5 and m from 10 to 50, more preferably wherein n is from 0 to 3 and m is from 15 to 40, and even more preferably wherein n is 0 and m is from 18 to 25. Surfactants according to this formula were particularly useful in reducing spotting of dishware treated in a machine dish washer. Preferably at least 50 wt. % of the nonionic surfactant comprised by the detergent composition of the invention is nonionic surfactant according to this formula. Such nonionic surfactants are commercially available, for example under the tradename Dehypon WET (Supplier: BASF) and Genapol EC50 (Supplier Clariant).

The detergent composition of the invention comprises from 0.1 to 20 wt. % of a nonionic surfactant or a mixture of two or more non-ionic surfactants. The preferred amount of total non-ionic surfactant if from 1 to 18 wt. %, more preferably from 4 to 16 wt. % and even more preferably from 6 to 12 wt. %. Such levels are considered optimal.

The nonionic surfactant is preferably present in amounts of 25 to 90 wt. % based on the total weight of the surfactant system. Anionic surfactants can be present for example in amounts in the range from 5 to 40 wt. % of the surfactant system.

### Aminopolycarboxylate

Aminopolycarboxylates are well known in the detergent industry and sometimes referred to as aminopolycarboxylic acids chelants. They are generally appreciated as being strong builders. Suitable aminopolycarboxylic acids include glutamic acid N,N-diacetic acid (GLDA), methylglycinediacetic acid (MGDA), ethylenediaminedisuccinic acid (EDDS), iminodisuccinic acid (IDS), iminodimalic acid (IDM), ethylenediaminetetraacetic acid (EDTA), nitrilotriacetic acid (NTA), iminodiacetic acid (IDA), diethylenetriaminepentaacetic acid (DTPA), hydroxyethyliminodiacetic acid (HEIDA) aspartic acid diethoxysuccinic acid (AES) aspartic acid-N,N-diacetic acid (ASDA), hydroxyethylene-diaminetetraacetic acid (HEDTA), hydroxyethylethylene-diaminetriacetic acid (HEEDTA), iminodifumaric (IDF), iminoditartaric acid (IDT), iminodimaleic acid (IDMAL), ethylenediaminedifumaric acid (EDDF), ethylenediaminedimalic acid (EDDM), ethylenediamineditartaric acid (EDDT), ethylenediaminedimaleic acid and (EDDMAL), dipicolinic acid.

Preferred aminopolycarboxylates are GLDA, MGDA, EDDS, IDS, IDM or a mixture thereof, more preferred are GLDA, MGDA, EDDS or a mixture thereof and even more preferred are GLDA and MGDA or a mixture thereof. Of these GLDA is especially preferred as it can be made from bio-based materials (e.g. monosodium glutamate, which itself can be made as by-product from corn fermentation). Also, GLDA itself is highly biodegradable. MGDA is more preferred in view of it being somewhat less hygroscopic, which improves detergent stability during storage.

The detergent composition according to the invention comprises from 0.5 to 40 wt. % free acid equivalent of aminopolycarboxylate. A particularly preferred amount of free acid equivalent of aminopolycarboxylate is from 0.5 to 20 wt. %, more preferably from 1.0 to 15 wt. %, even more preferably from 2.0 to 10 wt. % and still even more preferably from 3.0 to 8 wt. %.

Preferred salts are alkali-based salts and more preferred are sodium-based salts.

### Hydroxamic Acid and Derivatives

The general structure of the hydroxamic acid of the invention has been indicated above. When R¹, is an alkyl ether group CH₃ (CH₂)ₙ (EO)ₘ wherein n is from 2 to 20 and m is from 1 to 12 then the alkyl moiety terminates this side group. Preferably, R¹ a is a straight or branched unsubstituted C₄-C₂₀ alkyl. More preferably the alkyl is a C₆-C₁₈, even more preferably a C₈-C₁₄, and still even more preferably a C₈-C₁₂ alkyl. The numbers are averages. Most advantageous are C₈ alkyl. The alkyl chains are beneficially unbranched Octyl hydroxamic acid was found to be particularly useful:

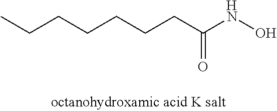

However, other hydroxamic acids, whilst less preferred, are suitable for use in the present invention. Such suitable compounds include, but are not limited to, the following compounds:

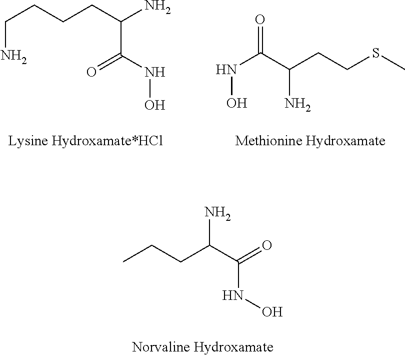

Such hydroxamic acids are commercially available.

The preferred R₂ moiety is hydrogen.

The preferred free acid equivalent of hydroxamate is from 0.7 to 3.5 wt. %, more preferably from 0.8 to 3.0 wt. % and even more preferably from 1.0 to 2.5 wt. %.

### pH Profile

The detergent composition of the invention advantageously provides a pH of a solution of 1 wt. % of the detergent composition in water as measured at 25 degrees Celsius of from 7.0 to 12.0, more preferably of from 8.0 to 11.0 and even more preferably of from 8.5 to 10.5.

### Further Ingredients

The detergent composition of the invention may comprise further ingredients, such as further detergent active components.

### Organic Acid

Inclusion of further organic acids and/or their corresponding salts (not being aminopolycarboxylic acids or hydroxamic acids) is beneficial in providing improved detergency whilst capable of being made from renewable materials (e.g. plant-based) and readily biodegradable.

Said further organic acid used in the detergent composition of the invention can be any organic acid. Particularly good results were achieved with organic acids being polyacids (i.e. acids having more than one carboxylic acid group), and more particularly with di- or tricarboxylic organic acids. The organic acids used in the invention have an average molecular mass of at most 500 Dalton, more preferably of at most 400 Dalton and most preferably of at most 300 Dalton, the molecular mass being based on the free acid equivalent. In any case, preferably the organic acid is not a polymer-based acid. The organic acid employed in accordance with the invention preferably comprises 3 to 25 carbon atoms, more preferably 4 to 15 carbon atoms.

In view of consumer acceptance and reducing environmental impact, the organic acids preferably are those which are also found naturally occurring, such as in plants. As such, organic acids of note are acetic acid, citric acid, aspartic acid, lactic acid, adipic acid, succinic acid, glutaric acid, malic acid, tartaric acid, maleic acid, fumaric acid, saccharic acids, their salts, or mixtures thereof. Of these, of particular interest are citric acid, aspartic acid, acetic acid, lactic acid, succinic acid, glutaric acid, adipic acid, gluconic acid, their salts, or mixtures thereof. Citric acid was found highly advantageous. Citric acid is naturally occurring, highly biodegradable as well as providing added builder activity and disintegration properties.

Advantageously the detergent composition of the invention comprises a free acid equivalent of organic acid of from 1 to 30 wt. %, more preferably of from 5 to 20 wt. % and even more preferably from 8.0 to 15 wt. %.

Preferred salt forms of the further organic acid are alkali metal salts and beneficially their sodium salts.

### Further Builders

Further builder materials may be selected from 1) calcium sequestrant materials, 2) precipitating materials, 3) calcium ion-exchange materials and 4) mixtures thereof.

Examples of calcium ion-exchange builder materials include the various types of water-insoluble crystalline or amorphous aluminosilicates, of which zeolites are known representatives, e.g. zeolite A, zeolite B (also known as zeolite P), zeolite C, zeolite X, zeolite Y and also the zeolite P-type as described in EP-A-0,384,070. Zeolite and carbonate (carbonate (including bicarbonate and sesquicarbonate) are preferred further builders. The builder may be crystalline aluminosilicate, preferably an alkali metal aluminosilicate, more preferably a sodium aluminosilicate. This is typically present at a level of less than 15 wt. %. Aluminosilicates are materials having the general formula: 0.8-1.5 M₂O. Al₂O₃. 0.8-6 SiO₂, where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alkali carbonate is appreciated in view of its double function as builder and buffer and is preferably present in the detergent composition. The preferred amount of alkali carbonate in the detergent composition is from 2 to 75 wt. %, more preferably from 10 to 50 wt. % and even more preferably from 20 to 40 wt. %. Such level of alkali carbonate provides good Ca²⁺ and Mg²⁺ ion scavenging for most types of water hardness levels, as well as other builder effects, such as providing good buffering capacity. The preferred alkali carbonates are sodium- and/or potassium carbonate of which sodium carbonate is particularly preferred. The alkali carbonate present in the detergent composition of the invention can be present as such or as part of a more complex ingredient (e.g. sodium carbonate in sodium percarbonate).

The detergent composition is phosphate-free, i.e., contains at most 1.0 wt. %, preferably at most 0.8 wt. %, more preferably at most 0.5 wt. %, even more preferably at most 0.2 wt. % of phosphate and still even more preferably contains essentially no phosphate. The detergent composition is phosphonate-free i.e., contains at most 1.0 wt. % of phosphonate, preferably at most 0.8 wt. %, more preferably at most 0.5 wt. %, even more preferably at most 0.2 wt. % of phosphonate and still even more preferably contains essentially no phosphonate. Examples of phosphonates and phosphates are 1-hydroxyethane-1,1-diphosphonic acid (HEDP), diethylenetriamine-penta (methylenephosphonic acid) (DTPMP), ethylenediaminetetra-methylenephosphonate (EDTMP), tripolyphosphate and pyrophosphate.

### Bleach

The detergent composition of the invention preferably comprises from 0.1 to 25 wt. % of bleach. Inorganic and/or organic bleaches can be used. Bleach may be selected from peroxides, organic peracids, salts of organic peracids and combinations thereof. Advantageously the bleach is selected from peroxides (including peroxide salts such as sodium percarbonate), organic peracids, salts of organic peracids and combinations thereof. More preferably, the bleach is a peroxide. Most preferably, the bleach is a percarbonate. Further preferred, the bleach is a coated percarbonate. More preferred amounts of bleach are from 1.0 to 25 wt. %, even more preferably at from 2.0 to 20 wt. % and still even more preferably from 5 to 15 wt. %.

### Bleach Activators

The detergent composition of the invention preferably comprises one or more bleach activators such as peroxyacid bleach precursors. Peroxyacid bleach precursors are well known in the art. As non-limiting examples can be named N, N, N′,N′-tetraacetyl ethylene diamine (TAED), sodium nonanoyloxybenzene sulphonate (SNOBS), sodium benzoyloxybenzene sul phonate (SBOBS) and the cationic peroxyacid precursor (SPCC) as described in U.S. Pat. No. 4,751,015. A beneficial amount of bleach activator is from 0.1 to 10 wt. %, more preferably from 0.5 to 5 wt. % and even more preferably from 1.0 to 4 wt. %.

### Bleach Catalyst

Bleach catalysts function by oxidizing typically via peroxide or a peracid to form a bleaching species. They require the presence of an oxidizable soil so that they can be reduced back to the starting bleach activator state. A preferred bleach catalyst is a manganese complex of formula (A):

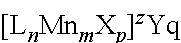

wherein Mn is manganese, which can be in the II, III, IV or V oxidation state or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule of the general formula:

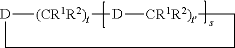

wherein R¹ and R² can each be zero, H, alkyl or aryl optionally substituted; t and t′ are each independent integers from 2-3; each D can independently be N, NR, PR, O or S, where R is H, alkyl or aryl, optionally substituted; and s is an integer from 2-5. Such bleach catalysts are described in EP0458397A2.

The beneficial amount of bleach catalyst is from 0.0001 to 2.0 wt. %, more preferably from 0.001 to 1.5 wt. %, even more preferably from 0.01 to 1.0 wt. %.

### Surfactant

In addition to the nonionic surfactant the detergent composition of the invention may comprise one or more further surfactants. Anionic surfactants may be chosen from the anionic surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

Amineoxide surfactants may also be used in the present invention as anti-redeposition surfactant. Examples of suitable amineoxide surfactants are C10-C18 alkyl dimethylamine oxide and C10-C18 acylamido alkyl dimethylamine oxide.

### Anionic Surfactants

If present the amount of anionic surfactant is preferably is at most 5 wt. %, and more preferably at most 2 wt. % and even more preferably at most 1.5 wt. %. Examples of suitable anionic surfactants are methylester sulphonates or sodium lauryl sulphate.

Advantageously the detergent according to the invention comprises essentially no anionic surfactant. Anionic surfactants are nowadays usually derived (in part) from non-renewable carbon sources and often are poorly biodegradable. Hence having essentially no anionic surfactants shortens the ingredient list and reduces the environmental impact of the detergent composition.

### Enzymes

The detergent composition of the invention preferably comprises enzyme. Examples of enzymes suitable for use in the cleaning compositions of this invention include lipases, cellulases, peroxidases, proteases (proteolytic enzymes), amylases (amylolytic enzymes) and others. Well-known and preferred examples of these enzymes are proteases, amylases, cellulases, peroxidases, mannanases, pectate lyases and lipases and combinations thereof, of which proteolytic and amylolytic enzymes are the more preferred. Enzymes may be added in liquid, granular or in encapsulated form to the composition, but preferably are not encapsulated. If enzymes are present the composition preferably also contains enzyme stabilizers such as polyalcohols/borax, calcium, formate or protease inhibitors like 4-formylphenyl boronic acid.

Preferred levels of protease are from 0.1 to 10 mg, more preferably from 0.2 to 5 mg, most preferably 0.4 to about 4 mg active protease per gram of the detergent composition. Preferred levels of amylase are from 0.01 to 5, more preferably from 0.02 to 2, most preferably from 0.05 to about 1 mg active amylase per gram of the detergent composition.

### Dispersing Polymers

The detergent composition of the invention beneficially comprises dispersing polymer. Dispersing polymers can be chosen from the group of anti-spotting agents and/or anti-scaling agents. Examples of suitable anti-spotting polymeric agents include hydrophobically modified polycarboxylic acids such as Acusol™460 ND (ex Dow) and Alcosperse™747 by Nouryon, whereas also synthetic clays, and preferably those synthetic clays which have a high surface area can be useful to reduce spotting, in particular those formed where soil and dispersed remnants are present at places where the water collects on the floor when the water subsequently evaporates.

Suitable anti-scaling agents are water soluble dispersing polymers prepared from an allyloxybenzenesulfonic acid monomer, a methallyl sulfonic acid monomer, a copolymerizable nonionic monomer and a copolymerizable olefinically unsaturated carboxylic acid monomer as described in U.S. Pat. No. 5,547,612 or known as acrylic sulphonated polymers as described in EP851022. Polymers of this type include polyacrylate with methyl methacrylate, sodium methallyl sulphonate and sulphophenol methallyl ether such as Alcosperse™240 supplied (Nouryon). Also suitable is a terpolymer containing polyacrylate with 2-acrylamido-2 methylpropane sulphonic acid such as Acumer 3100 supplied by Dow. As an alternative, polymers and co-polymers of acrylic acid having a molecular weight between 500 and 20,000 can also be used, such as homo-polymeric polycarboxylic acid compounds with acrylic acid as the monomeric unit. The average weight of such homo-polymers in the acid form preferably ranges from 1,000 to 100,000 particularly from 3,000 to 10,000 e.g. Sokolan™ PA 25 from BASF or Acusol™425 from Dow. Also suitable are polycarboxylates co-polymers derived from monomers of acrylic acid and maleic acid, such as CP5 from BASF. The average molecular weight of these polymers in the acid form preferably ranges from 4,000 to 70,000. Modified polycarboxylates like Sokalan™ CP50 from BASF or Alcoguard™4160 from Nouryon may also be used. Mixture of anti-scaling agents may also be used. Particularly useful is a mixture of organic phosphonates and polymers of acrylic acid.

If present, the preferred amount of dispersing polymer is from 0.1 to 6 wt. %, more preferably from 0.2 to 4 wt. %, and even more preferably from 0.3 to 2 wt. %.

### Perfume and Colorants

The detergent composition preferably comprises one or more colorants, one or more perfumes and more advantageously a mixture of at least one colorant and at least one perfume. Colorants are beneficially present in an amount of from 0.0001 to 8 wt. %, more preferably from 0.001 to 4 wt. % and even more preferably from 0.001 to 1.5 wt. %.

Perfume may be present in the range from 0.1 to 1 wt. %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co. In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

### Form of the Detergent Composition

The detergent composition of the invention may be in any suitable form, such as in the form of a liquid (e.g. gel), powder or a mixture thereof (e.g. a multi-compartmental capsule). They may be in unit-dose or non-unit dose form. Examples of unit-dose forms are tablets and capsules.

The detergent composition is preferably provided as a water-soluble or water-dispersible unit dose. Particularly preferred unit doses are in the form of pouches, which comprise at least one further non-shape stable ingredient, such as a liquid and/or powder; or in the form of tablets. For ease of use, the unit dose is sized and shaped as to fit in the detergent cup of a conventional domestic machine dishwasher. In a preferred embodiment, the unit-dose detergent composition has a unit weight of 5 to 50 grams, more preferably a unit weight of 10 to 30 grams, even more preferably a unit weight of 12 to 25 grams. Advantageous unit dose pouches preferably have more than one compartment. Advantageous unit dose tablets are those which have more than one visually distinct tablet region. Such regions can be formed by e.g. two distinct (colored) layers or a tablet having a main body and a distinct insert, such as forming a nested-egg. However oriented, one benefit of using multi-compartmental pouches/multi-region tablets is that it can be used to reduce/prevent undesired chemical reactions between two or more ingredients during storage by physical segregation.

Preferably the unit dose detergent composition is wrapped to improve hygiene and consumer safety. The wrapper advantageously is based on water-soluble film which preferably a polyvinylalcohol (PVA) based film. Such wrapping prevents direct contact of the detergent composition with the skin of the consumer when placing the unit dose in the detergent cup/holder of a e.g. machine dishwasher. A further benefit of course is that the consumer also does not need to remove a water-soluble wrapping before use.

The detergent compositions according to the invention can be made using known methods and equipment in the field of detergent composition manufacturing.

Unless stated otherwise or is apparent from the context of the description, preferred embodiments mentioned for one aspect of the invention applies mutated mutandis to the other aspects of the invention as well. The below examples are meant to be illustrative and not limiting.

### EXAMPLES

### Example 1

A base detergent composition in the form of a tablet was made as set out in Table 1.

TABLE 1
Machine dishwash detergent tablets
(amounts as expressed by wt. %).

| Ingredient | |
|---|---|
| Na carbonate | 35.0 |
| MGDA | 12.0 |
| Tri-Na citrate | 9.9 |
| Na Disilicate | 4.0 |
| Na Sulphate | 5.6 |
| ¹nonionic | 3.6 |
| Na percarbonate | 11.4 |
| TAED | 2.8 |
| Bleach catalyst | 0.01 |
| ²enzymes | 1.7 |
| ³polymer | 2.8 |
| Minors (e.g. dye, perfume, antifoam) | <1.0 |
| Water | To balance |

¹nonionic: mixture of Plurafac LF301 (Supplier: BASF) and Lutensol AT80 (Supplier: BASF)
²enzymes: mixture of protease and amylase (Supplier Novozymes)
³polymer: Sokalan PA25CL (Supplier: BASF)

The tablet was used in a machine dishwash program (as set out below) in combination with either 2 wt. % octyl hydroxamate potassium salt (Example 1), 5 wt. % octyl hydroxamate potassium salt (Comparative A) or 2 wt. % HEDP (Comparative B) or with no further addition (i.e. just the tablet, Comparative C). Note: e.g. 2 wt. % octyl hydroxamate potassium salt would be 1.6 wt. % free acid equivalent.

### Machine Dishwash Method

The detergents according to Example 1, Comparative A, B or C were dosed in the detergent-cup holder of a Miele GSL machine dishwasher. The dishwasher was loaded with earthenware plates including 1 cup of ballast soil STIWA soil (available from StaDe Testmaterialien). The dishwasher was run at a 50 degrees Celsius program with 35°/25° F. water hardness. The dishwasher was run 6 times according to the above method. After the 6^{th} wash the plates were evaluated.

### Results

The earthenware plates were assessed by an expert panel and scored for the incidence of spotting. The degree of spotting was classed in a score of 0 to 9 where a higher score indicates less spotting. The results are shown in Table 2.

TABLE 2
Results of the incidence of spotting (higher number is less spotting)

| | | Comparative | Comparative | Comparative |
|---|---|---|---|---|
| | Example 1 | A | B | C |
| Spotting Result | 2 | 1 | 1 | 1 |

What can be readily appreciated from the results is that the use of octyl hydroxamate in an amount according to the invention leads to appreciably less spotting on the earthenware washed when compared to usage of higher dose not according to the claim (Comparative A), the use of HEDP (Comparative B) or to using just the tablet without further additive (Comparative C).

1. A machine dishwash detergent composition comprising:
from 0.1 to 20 wt. % non-ionic surfactant; and
from 0.5 to 40 wt. % of free acid equivalent of aminopolycarboxylate; and
from 0.5 to 3.8 v 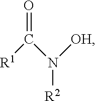
wherein R¹ is a straight or branched C₄-C₂₀ alkyl, or a straight or branched substituted C₄-C₂₀ alkyl, or a straight or branched C₄-C₂₀ alkenyl, or a straight or branched substituted C₄-C₂₀ alkenyl, or an alkyl ether group CH₃ (CH₂)ₙ (EO)ₘ wherein n is from 2 to 20 and m is from 1 to 12, or a substituted alkyl ether group CH₃ (CH₂)ₙ (EO)ₘ wherein n is from 2 to 20 and m is from 1 to 12, and
the types of substitution include one or more of —NH₂, —OH, —S—, —O—, —COOH, and 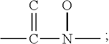
and R² is selected from hydrogen and a moiety that forms part of a cyclic structure with a branched R¹ group, and
wherein the amount of phosphate is at most 1.0 wt. %; and
wherein the amount of phosphonate is at most 1.0 wt. %.

2. The detergent composition according to claim 1, wherein the free acid equivalent of hydroxamate is from 0.7 to 3.5 wt. %, preferably from 0.8 to 3.0 wt. % and more preferably from 1.0 to 2.5 wt. %.

3. The detergent composition according to claim 1, wherein R¹ is a straight or branched unsubstituted C₄-C₂₀ alkyl, preferably a C₆-C₁₈ alkyl, even more preferably a C₈-C₁₄ alkyl and still even more preferably a C₈-C₁₂ alkyl.

4. The detergent composition according to claim 1, wherein the composition comprises from 0.5 to 20 wt. % free acid equivalent of aminopolycarboxylate.

5. The detergent composition according to claim 4, wherein the aminopolycarboxylate comprises GLDA (glutamic acid N,N-diacetic acid), MGDA (methylglycinediacetic acid), EDDS (ethylenediaminedisuccinic acid) or a mixture thereof.

6. The detergent composition according to claim 1, wherein the composition comprises from 1 to 30 wt. % free acid equivalent of organic acid having an average molecular mass of at most 500 Dalton, wherein the organic acid is different from aminopolycarboxylate and hydroxamate.

7. The detergent composition according to claim 6, wherein the organic acid comprises di- or tri-carboxylic acids, or mixtures thereof having a free acid equivalent average molecular mass of at most 400 Dalton, wherein the acids include their corresponding salts.

8. The detergent composition according to claim 1, wherein the total amount of non-ionic surfactant is from 1 to 18 wt. %.

9. The detergent composition according to claim 1, wherein the pH of a 1 wt. % solution of the detergent composition in water at 25 degrees Celsius and in otherwise standard conditions provides a pH of at from 7.0 to 12.

10. The detergent composition according to claim 1, wherein the composition comprises at most 0.5 wt. % phosphonate.

11. The detergent composition according to claim 1, wherein the composition comprises at most 0.5 wt. % phosphate.

12. The detergent composition according to claim 1, comprising from 0.1 to 25 wt. % of bleach.

13. The detergent composition according to claim 1, wherein the composition comprises one or more colorants, one or more perfumes or a combination thereof.

14. The detergent composition according to claim 1, wherein the detergent composition is in the form of a unit dose composition.
